(19) United States
(12) Patent Application Publication
(10) Pub. No.: US 2003/0232231 A1
(43) Pub. Date: Dec. 18, 2003

(54) Device and method for supplying air to a fuel cell

(75) Inventors: Manfred Stute, Esslingen (DE); Siegfried Sumser, Stuttgart (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/417,944

(22) Filed: Apr. 17, 2003

(30) Foreign Application Priority Data
Apr. 17, 2002 (DE) 102 16 953.5

(51) Int. Cl. H01M 8/04

(52) U.S. Cl. 429/34; 429/26

(57) ABSTRACT

A device for supplying air to a fuel cell includes a compression machine connected at the intake air side of the fuel cell and an expansion machine connected at the exhaust air side of the fuel cell. The expansion machine is disposed on a common shaft with the compression machine. A motor-driven compression machine is connected downstream from the expansion machine on the exhaust air side.

Priority is claimed to German patent application 102 16 953.5, filed Apr. 17, 2002, and which is hereby incorporated by reference herein.

The present invention relates generally to a device for supplying air to a fuel cell, and in particular to a device for supplying air to a fuel cell using a compression machine

### BACKGROUND

European Patent 0 629 013 B2 describes a device for supplying air to a fuel cell system. This device for supplying an air-breathing fuel cell has a compressor having a variable rotational speed in the air supply line to the fuel cell and has an expander in the air exhaust line having a variable absorption capacity, both being located on a common shaft. In addition, an electric motor is also situated on the common shaft, supplying at least a portion of the power required for compression of the air supplied, while the remaining portion of the required power is supplied by the expander. The defined air volume flow is set at defined set points with the help of the current regulator on the basis of a rotational speed regulation for the electric motor, and the defined operating pressure is set at defined set points with the help of the absorption capacity of the expander.

In the design described in the aforementioned European patent publication, a portion of the energy expended in compression of air may be recovered using the expander. The additional power required for the air supply is provided in the system by the electric motor, which is situated on a common shaft together with the expander and the compressor.

Other concepts for the air supply to a fuel cell system use a similar design of an expander and a compressor, but, if necessary, these may also form just one stage of a multistage system for air supply to a fuel cell. To provide adequate power using the expander, catalytic burners are provided in these systems, as described in German Patent Application 199 56 376 A1 and European Patent Application 1 009 053 A1, for example. These catalytic burners increase the temperature of the gases before the latter are introduced into the expander, so that enough power for compression of the air may be applied by the expander. The power required for this in the catalytic burner comes from unconverted residues of hydrogen and hydrocarbon in the exhaust gas on the anode side of the fuel cell, which are mixed upstream from the burner with the exhaust air on the cathode side.

All the designs mentioned above are relatively complex with regard to regulation of the air supply because they depend on the temperature level in the catalytic burner, the throughput of educts suitable for combustion, etc. Furthermore, there is a time lag in providing the power, because first a sufficiently large amount of air must be conveyed through the fuel cell before the catalytic burner is capable of supplying a higher power yield and thus providing a larger amount of power for compression accordingly. Power is thus provided for the compressor with a time lag. If dynamic operation of the fuel cell is essential, the required power must be provided by some other means in the short term, whether from a battery-powered electric motor or by direct supply of fuels and air to the catalytic burner.

### SUMMARY OF THE INVENTION

It is an object of the present invention to provide a device and a method for supplying air to a fuel cell in such a way as to avoid the disadvantages mentioned above and provide a small, simple, lightweight, and dynamically operable system for supplying air to a fuel cell, so that the system will have a low power consumption.

The present invention provides a device for supplying air to a fuel cell, including a compression machine on the intake air side and an expansion machine on the exhaust air side situated on a common shaft together with the compression machine on the intake air side. A motor-driven compression machine (8) is situated downstream from the expansion machine (6) on the exhaust air side.

A simple and efficient means of supplying power is created by the motor-driven compression machine located on the exhaust air side downstream from the expansion machine. Thus, it is possible to establish a pressure level below ambient pressure downstream from the expansion machine, the power to be generated by the expansion machine optionally being used to drive the intake air side compression machine situated on a shaft together with the expansion machine.

Therefore, a very simple and inexpensive freewheel without any additional electric motor may be used as the expansion machine and the compression machine on the intake air side, this being known per se from turbochargers in the case of internal combustion engines. Because of the high rotational speed, this freewheel may then be very small and lightweight, which is of particular advantage, especially when used for small fuel cell systems in mobile applications, e.g., to operate a motor vehicle or as an auxiliary power unit (APU) in a motor vehicle.

In an especially advantageous refinement of the device defined above, a condenser may be provided between the expansion machine and the motor-driven compression machine.

This condenser is thus situated in an area in which a pressure level lower than the ambient pressure level would normally prevail. The conditions for condensing water out of the exhaust air carrying it are ideal in this area, so the at least approximate majority of the product water of the fuel cell carried away with the exhaust air may be recovered in the area of this condenser. This makes it easy to achieve a good water balance and thus to operate the fuel cell, i.e., the fuel cell system, without having to tank up with water again.

The present invention also provides a method of supplying air to a fuel cell, the air being compressed by a compression machine, which is designed as a flow compressor installed on the intake air side, arranged on a common shaft together with an expansion turbine which has a variable turbine guide vane grid and is situated on the exhaust air side. The supply of air is regulated and/or controlled via the rotational speed of the compression machine. The rotational speed of the compression machine (3) is regulated and/or controlled by the variable turbine guide vane grid (7) and a motor-driven compression machine (8) situated downstream from the expansion turbine (6).

Since the rotational speed of the compression machine is controlled and/or regulated by the variable turbine guide vane grid and the motor-driven compression device situated downstream from the turbine, it is therefore possible to influence the supply of air in a very simple and efficient manner.

Here again, the advantage mentioned above also plays a major role, namely that a simple and efficient combination of a turbine and a compression machine on the intake air side may be used due to control and/or regulation via the turbine guide vane grid, which is known per se, and the compression machine downstream from the turbine. Such sturdy and basically known freewheels are used per se as turbochargers for internal combustion engines, as mentioned above, so this results in a simple, inexpensive, and compact design, in particular due to the possibility of using high rotational speeds accordingly, which in turn contributes toward minimization of the size and weight of the turbine and the expander on the intake air side.

An advantageous use of the device and/or method described above is to supply air to an air-breathing fuel cell in a mobile application, in particular in a motor vehicle.

Especially in such an application, frequently operating in the partial load range, a high efficiency and a very small, lightweight, and sturdy system capable of meeting high dynamic requirements play an especially important role. The device and/or method described above make it possible to utilize these advantages in supplying air to a fuel cell. The fuel cell may supply the power to drive the mobile system or it may be used as an auxiliary power unit (APU).

### BRIEF DESCRIPTION OF THE DRAWING

The present invention is elaborated upon below based on exemplary embodiments, with reference to drawing, in which:

FIG. 1 shows a schematic diagram of a device for supplying air to a fuel cell.

### DETAILED DESCRIPTION

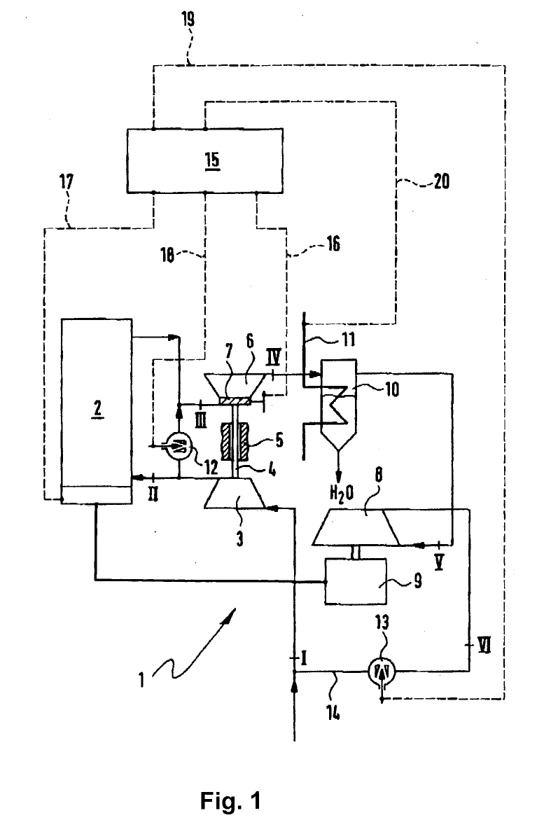

FIG. 1 shows a device 1 for supplying air to a fuel cell 2. For optimizing efficiency, device 1 of fuel cell 2 supplies the air at a pressure of less than 2.5 bar abs. Due to this measure, which known per se, it is possible to minimize the use of power required for the air supply without having a negative effect on operation of the fuel cell. Device 1 for supplying air to fuel cell 2 is thus designed as an air supply system for a low-pressure fuel cell, but this should not restrict the present invention to this exemplary embodiment.

On the basis of the desired low admission pressure of fuel cell 2, a one-step compression of the air from ambient pressure P_{I} (state I) to pressure level P_{II} of low-pressure fuel cell 2, generally less than 2.5 bar abs., preferably less than 2 bar abs. (state II), may be implemented. Compression machine 3 used for this purpose is designed as a flow compressor 3, which is fixedly connected to an expansion machine 6 via a shaft 4 which runs in a bearing 5. The air is filtered in accordance with a common procedure before entering device 1 for the air supply and, if necessary, it is conditioned accordingly in the area between flow compressor 3 and fuel cell 2 before being supplied to fuel cell 2, e.g., conditioned by humidifying, cooling/heating, or the like.

Starting from state III, the exhaust air of fuel cell 2, which is laden with the vapor of product water formed in fuel cell 2, flows from fuel cell 2 into expansion machine 6, an expansion turbine 6 here. Depending on the power supplied instantaneously, i.e., the operating point, and the type of fuel cell 2 used, gas/steam temperatures in a range of 40° C. to 100° C. are typical. Accordingly, expansion turbine 6 is ideally designed as a radial turbine 6 being additionally provided with a variable turbine guide vane grid 7. The flow compressor and turbine 6 may be designed as very small, sturdy and simple freewheels which are operated at a high rotational speed.

The power and efficiency of turbine 6 may be influenced with variable turbine guide vane grid 7, so that intake pressure P_{II} of the air (state II) into fuel cell 2 may be influenced by direct coupling to the compression machine on the intake air side, namely flow compressor 3 here. Due to this influence on state II, the air throughput through fuel cell 2 is also determined, so the power capacity of fuel cell 2 is defined on the basis of the outlet side of flow compressor 3.

For supplying the required driving power of flow compressor 3, device 1 also has a motor-driven compression machine 8, preferably a radial compressor 8 driven by an electric motor 9. Electric motor 9 receives the electric power required for its operation from fuel cell 2 or, if necessary, from a power storage device in the form of a battery connected to fuel cell 2. This second option is important in particular for startup and for meeting high dynamic demands.

The effect of variable turbine guide vane grid 7 is directly related to the arrangement of radial compressor 8 as the power supply downstream from turbine 6. State IV downstream from turbine 6 depends on the narrowest cross section in the area of variable turbine guide vane grid 7 and thus on the suction effect of radial compressor 8. This means that radial compressor 8, which is driven by electric motor 9, supplies the power applied to it indirectly to expansion turbine 6 by producing desired expansion ratio P_{III}/P_{IV} at the set cross section in variable turbine guide vane grid 7 through its intake pressure P_{V} (state V). Radial compressor 8 is thus throttled by variable turbine guide vane grid 7 of turbine 6 and the elements provided downstream from it, if necessary, yielding compression ratio P_{VI}/P_{V} via the power from electric motor 9 when other components which generate a pressure drop of P=P_{V}−P_{IV} are situated between turbine 6 and radial compressor 8.

This pressure drop P could be created, e.g., by a condenser 10 which is situated advantageously at this location. Pressure P_{VI} (state VI) is then very close to or at least approximately equal to ambient pressure, taking into account the subsequent generally very low pressure drop in the exhaust system.

The basic circuit configuration of radial compressor 8 operating up to ambient pressure is shown in FIG. 1 in conjunction with the positioning of condenser 10 as already mentioned above with regard to its favorable design. Condenser 10 is used for condensing water (H₂O) out of exhaust air from fuel cell 2. It also has a heat exchanger 11 to permit thermal energy to be added to or removed from the area of condenser 10 for the purpose of heating and/or cooling the moist exhaust air, to improve condensation while preventing freezing.

Since it is situated between turbine 6 and radial compressor 8, condenser 10 is virtually always under a vacuum, i.e., at a pressure below ambient pressure. This greatly facilitates the removal of water from the steam/gas mixture in the exhaust air. A typical pressure in the area of condenser 10 would be up to 400 mbar abs. or less. These low pressures are made possible due to the fact that variable turbine guide vane grid 7 of turbine 6 may be set so that very narrow cross sections are possible in the area of turbine guide vane grid 7 here. Depending on the expansion pressure ratio of turbine 6, a drop in temperature of 50° K. to 70° K. from the intake of turbine 6 to the outlet of turbine 6, i.e., to the intake into condenser 10, is thus also possible. In cold weather, this might result in ice on the turbine outlet and/or condenser 10. For this reason, in addition to the cooling of the condenser, which is usually performed to improve condensation of the steam/gas mixture, heat exchanger 11 of condenser 10 should also have the possibility of heating this steam/gas mixture. The heat exchange through heat exchanger 11 is ideally controlled or regulated as a function of the ambient temperature.

For energy reasons, a very low admission temperature of the gas into radial compressor 8 is desirable in order to achieve the best possible efficiency of the air supply, because compression efficiency is proportional to admission temperature. However, since icing on condenser 10 would endanger the functioning of device 1 on the whole, an operating mode which practically rules out any risk of icing at the best possible efficiency will be selected via a suitable control and/or regulation of turbine guide vane grid 7, the heat exchange through heat exchanger 11 and electric motor 9.

In addition, to ensure stable operation of flow compressor 3, a bypass valve 12 may also be provided in device 1. The outlet of flow compressor 3 is connected directly to the intake of turbine 6 via this bypass valve 12, so the air is conducted in the bypass around fuel cell 2. This bypass valve 12 may be very beneficial in particular when starting up fuel cell 2 or when there are very dynamic changes in the operating point of fuel cell 2, because turbine 6 is able to maintain a higher energy flow in these phases with bypass valve 12 open than when all the air must first pass through fuel cell 2 without being needed there to generate electricity.

In addition, short-circuiting of the outlet of radial compressor 8 (state VI) and of intake (state I) of flow compressor 3 via a short-circuit valve 13 might also be appropriate in the startup phase or in other non-steady-state operating phases of fuel cell 2, in particular at very cool ambient temperatures, until the optimum operating temperature has been established in the overall system, in particular in fuel cell 2. In this phase of operation, an adjustable throttling device would also be appropriate in the area of the connection of pipeline 14 having short-circuit valve 13 to the intake pipeline of flow compressor 3 in order to be able to establish here the recycle rate amount of heated air into the incoming air. Depending on the oxygen content required in the area of fuel cell 2, this recycle rate of heated air might be selected to be as high as possible, so that as little thermal energy as possible is “wasted” and very rapid warm-up of fuel cell 2 is possible.

With regard to bearing 5 of shaft 4 of the freewheel of flow compressor 3 and turbine 6, as already mentioned above, the bearing selected here should ensure that the air supplied to fuel cell 2 is free of oil and other residues. Bearing 5 may be, for example, an air-cushion bearing, a magnetic bearing, or even a correspondingly well-sealed bearing device using oil or some other lubricant.

The entire device 1 for supplying air to fuel cell 2 is controlled and/or regulated by a control unit 15. Control unit 15 influences variable turbine guide vane grid 7, e.g., via line 16. The amount of power supplied by fuel cell 2 to electric motor 9 may be influenced via line 17 accordingly, so that electric motor 9 may be controlled by control unit 15 in accordance with its power and/or rotational speed or it may be regulated with appropriate feedback. Likewise, control unit 15 is responsible for operation of bypass valve 12 and/or short-circuit valve 13 via lines 18, 19 and regulation of heat exchange via heat exchanger 11 over control line 20, in each case using corresponding actuators which are known per se. The method sequences described above may thus be defined and controlled and/or regulated by control unit 15 as a function of the operating state of fuel cell 2, the ambient temperature, etc.

What is claimed is:

1. A device for supplying air to a fuel cell, comprising:
a compression machine connected at an intake air side of the fuel cell;
an expansion machine connected at an exhaust air side of the fuel cell, the expansion machine being disposed on a common shaft with the compression machine; and
a motor-driven compression machine connected downstream from the expansion machine on the exhaust air side.

2. The device as recited in claim 1 wherein the expansion machine includes an expansion turbine having a variable turbine guide vane grid.

3. The device as recited in claim 1 wherein the compression machine includes a flow compressor.

4. The device as recited in claim 1 wherein the motor-driven compression machine includes a radial compressor.

5. The device as recited in claim 1 further comprising a connection between the intake air side at the compression machine and the exhaust air side at the expansion machine.

6. The device as recited in claim 5 further comprising a bypass valve configured to control the connection.

7. The device as recited in claim 1 further comprising a condenser connected between the expansion machine and the motor-driven compression machine.

8. The device as recited in claim 7 further comprising a heat exchanger disposed in an area of the condenser.

9. The device as recited in claim 1 further comprising a bearing for the shaft, the bearing having an oil-free design.

10. The device as recited in claim 1 wherein an absolute pressure of the air supplied to the fuel cell is less than 2.5 bar upon admission into the fuel cell.

11. The device as recited in claim 1 wherein an output side of the motor-driven compression machine is connected to an intake side of the compression machine via at least one cut-off valve.

12. A method of supplying air to a fuel cell, comprising:
compressing the air using a compression machine, the compression machine including a flow compressor connected at an intake air side of the fuel cell and being disposed on a common shaft with an expansion turbine, the expansion turbine being connected at an exhaust air side of the fuel cell and including a variable turbine guide vane grid; and
controlling the rotational speed of the compression machine using the variable turbine guide vane grid and a motor-driven compression machine connected downstream from the expansion turbine so as to control the supplying of the air.

13. The method as recited in claim 12 further comprising starting the compression machine using the motor-driven compression machine during starting of the fuel cell.

14. The method as recited in claim 12 further comprising short-circuiting an intake of the compression machine and an outlet of the motor-driven compression machine during at least one of partial load operation and non-steady-state operation of the fuel cell so as to control the supplying of the air.

15. The method as recited in claim 14 further comprising controlling a rate of recycling of fuel cell exhaust air using the short-circuiting.

16. The method as recited in claim 12 bypassing air around the fuel cell into an intake of the expansion turbine during at least one of partial load operation and non-steady-state operation of the fuel so as to control the supplying of the air.

17. The method as recited in claim 12 further comprising:
providing a condenser connected between the expansion turbine and the motor-driven compression machine; and
regulating a heat exchange as a function of an ambient temperature in an area of the condenser.

18. The method as recited in claim 12 wherein the compressing the air is performed so as to generate a pressure of less than 2.5 bar absolute on the intake air side.

19. The method as recited in claim 12 wherein the fuel cell is configured to provide power to a mobile device.

20. The method as recited in claim 19 wherein the mobile device is a motor vehicle.
